(19) United States
(12) Patent Application Publication
(10) Pub. No.: US 2016/0208553 A1
(43) Pub. Date: Jul. 21, 2016

(54) LADDER STABILIZATION SYSTEM

(71) Applicant: Jackie Wayland, Hudson, FL (US)

(72) Inventor: Jackie Wayland, Hudson, FL (US)

(21) Appl. No.: 14/597,441

(22) Filed: Jan. 15, 2015

(51) Int. Cl. E06C 1/22; E06C 1/18; E06C 1/39

(52) U.S. Cl. CPC E06C 1/22; E06C 1/39; E06C 1/18

(57) ABSTRACT

A ladder stabilization system includes a ladder that has a pair of front legs and a pair of back legs. Each of the front legs and the back legs has a top end and a bottom end. The front legs and the back legs are positioned in a deployed positioned having the bottom end of the back legs being spaced apart from the bottom end of the front legs. The bottom ends may abut a support surface. A pair of supports is provided and each of the front legs has an outer surface and each of the outer surfaces has one of the supports attached thereto. Each of the supports is pivotally extendable laterally away from an associated one of the front legs to inhibit tipping of the ladder.

### BACKGROUND OF THE DISCLOSURE

### Field of the Disclosure

The disclosure relates to stabilization devices and more particularly pertains to a new stabilization device for preventing a ladder from tipping laterally while the ladder is being climbed.

### SUMMARY OF THE DISCLOSURE

An embodiment of the disclosure meets the needs presented above by generally comprising a ladder that has a pair of front legs, a pair of back legs and a platform. The platform has a front side and a back side. Each of the front legs and the back legs has a top end and a bottom end and the top end of each of the front legs and each of the back legs is hingedly coupled to the platform. The front legs are positioned adjacent to the front side and the back legs are positioned adjacent to the back side. The front legs and the back legs extend downwardly for the platform. The front legs and the back legs are positioned in a deployed positioned having the bottom end of the back legs being spaced apart from the bottom end of the font legs. The bottom ends may abut a support surface. A pair of supports is provided and each of the front legs has an outer surface and each of the outer surfaces has one of the supports attached thereto. Each of the supports is pivotally extendable laterally away from an associated one of the front legs to inhibit tipping of the ladder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a ladder stabilization system according to an embodiment of the disclosure.

FIG. 2 is a front view of an embodiment of the disclosure.

FIG. 3 is a left side view of an embodiment of the disclosure.

FIG. 4 is a cross sectional view taken along line 4-4 of FIG. 2 of an embodiment of the disclosure.

FIG. 5 is a cross sectional view taken along line 5-5 of FIG. 3 of an embodiment of the disclosure.

### DESCRIPTION OF THE PREFERRED EMBODIMENT

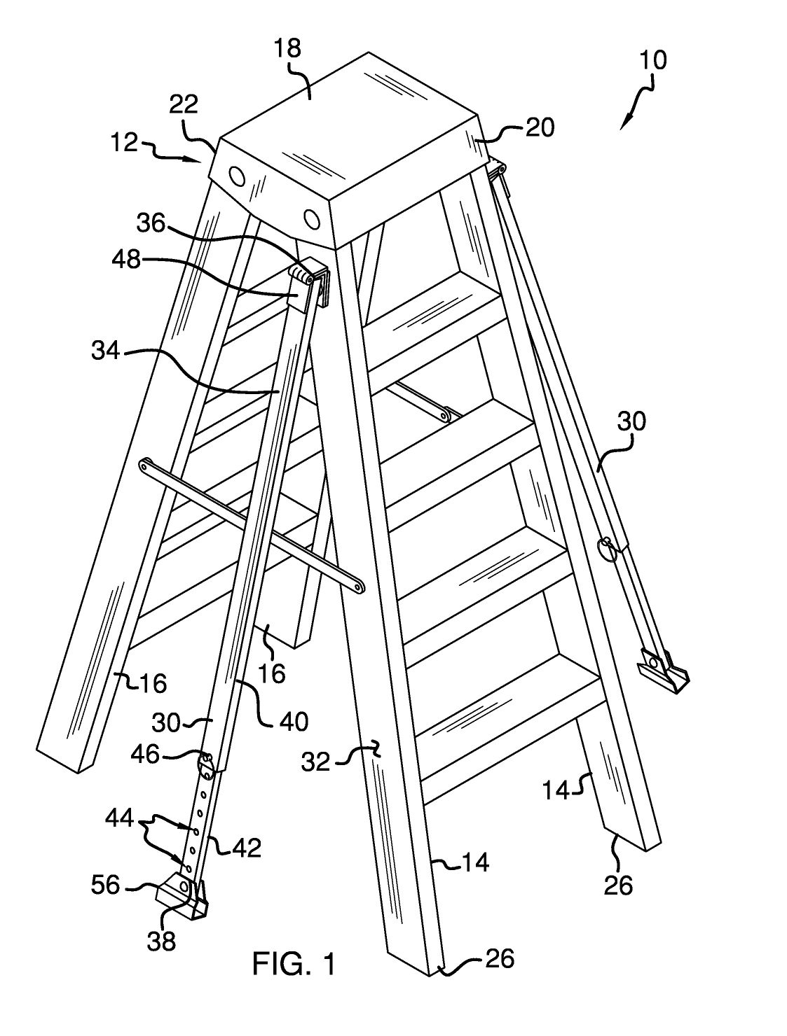

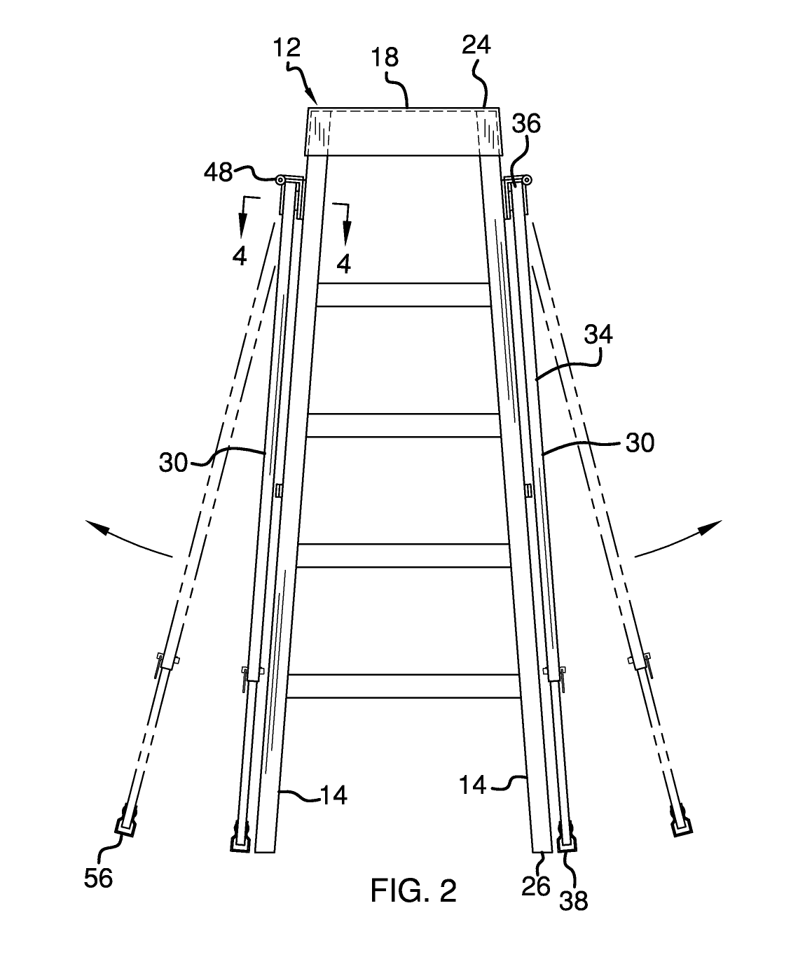

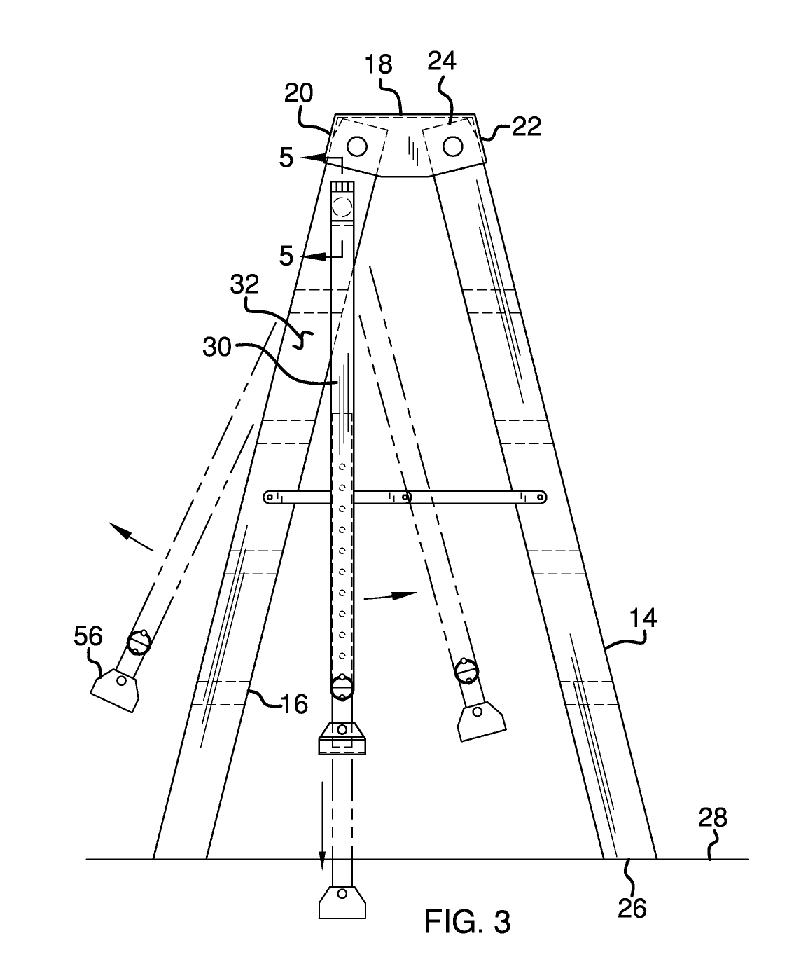

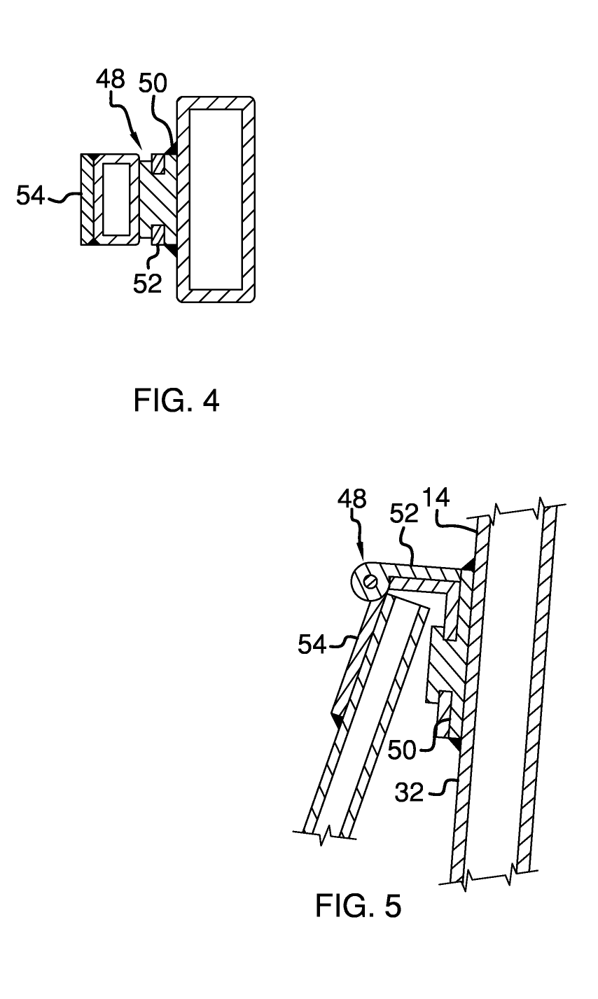

With reference now to the drawings, and in particular to FIGS. 1 through 5 thereof, a new stabilization device embodying the principles and concepts of an embodiment of the disclosure and generally designated by the reference numeral 10 will be described.

As best illustrated in FIGS. 1 through 5, the ladder stabilization system 10 generally comprises a ladder 12 that has a pair of front legs 14, a pair of back legs 16 and a platform 18. The platform 18 has a front side 20 and a back side 22 and each of the front legs 14 and the back legs 16 has a top end 24 and a bottom end 26. The top end 24 of each of the front legs 14 and each of the back legs 16 is hingedly coupled to the platform 18.

The front legs 14 are positioned adjacent to the front side 20 and the back legs 16 are positioned adjacent to the back side 22. The front legs 14 and the back legs 16 extend downwardly from the platform 18. The front legs 14 and the back legs 16 are positioned in a deployed positioned such that the bottom end 26 of the back legs 16 is spaced apart from the bottom end 26 of the front legs 14. The bottom ends 26 abut a support surface 28. The support surface 28 may be ground. The ladder 12 may be a step ladder or an extension ladder of any conventional design.

A pair of supports 30 is provided. The front legs 14 have an outer surface 32 and each of the outer surfaces 32 has one of the supports 30 attached thereto. Each of the supports 30 is pivotally extendable laterally away from an associated one of the front legs 14 to inhibit tipping of the ladder 12. Each of the supports 30 comprises a strut 34 that has an upper end 36 and a lower end 38. The strut 34 is telescopic and has a selectively adjustable length.

The strut 34 may comprise a top portion 40 slidably coupled to a bottom portion 42. The bottom portion 42 may have a plurality of apertures 44 extending laterally therthrough. The apertures 44 may be spaced apart and extend along the bottom portion 42. A pin 46 extends through the top portion 40 and engages a selected one of the apertures 44. The pin 46 retains the strut 34 at the selected length.

A coupler 48 is attached to the outer surface 28 and to the strut 34 adjacent to the upper end 36. The coupler 48 includes a mount 50 attached to the outer surface 32 and the mount 50 is rotational with respect to the ladder 12. A first arm 52 is attached to and extends outwardly from the mount 50. A second arm 54 is hingedly coupled to the first arm 52 and the strut 34 is attached to the second arm 54. Thus, the strut 34 is positioned in a deployed position having the strut 34 extending laterally away from the associated front leg 14. The strut 34 is rotatable with respect to the ladder 12 when the strut 34 is in the deployed position. The strut 34 is positioned in a stored position having the strut 34 being coextensive with the associated front leg 14. A foot 56 is attached to the lower end 38 and the foot 56 is pivotally coupled to the lower end 38.

In use, each of the front 14 and back 16 legs are positioned in the deployed position and the ladder 12 is positioned to be climbed. Each of the struts 34 is positioned in the deployed position and the length of the struts 34 is adjusted until the feet 36 abut the support surface 28. The ladder 12 is climbed and the struts 34 prevent the ladder 12 from tipping laterally while the ladder 12 is being climbed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ladder stabilization system configured to prevent a ladder from tipping laterally, said system comprising:
a ladder having a pair of front legs, a pair of back legs and a platform, said platform having a front side and a back side, each of said front legs and said back legs having a top end and a bottom end, said top end of each of said front legs and each of said back legs being hingedly coupled to said platform, said front legs being positioned adjacent to said front side, said back legs being positioned adjacent to said back side, said front legs and said back legs extending downwardly for said platform, said front legs and said back legs being positioned in a deployed positioned having said bottom end of said back legs being spaced apart from said bottom end of said font legs, said bottom ends being configured to abut a support surface; and
a pair of supports, each of said front legs having an outer surface, each of said outer surfaces having one of said supports attached thereto, each of said supports being pivotally extendable laterally away from an associated one of said front legs to inhibit tipping of said ladder.

2. The assembly according to claim 1, wherein each of said supports comprises a strut having an upper end and a lower end, said strut being telescopic and having a selectively adjustable length.

3. The assembly according to claim 2, further comprising a coupler being attached to said outer surface and to said strut adjacent to said upper end.

4. The assembly according to claim 3, wherein said coupler includes a mount attached to said outer surface, said mount being rotational with respect to said ladder.

5. The assembly according to claim 4, further comprising a first arm being attached to and extending outwardly from said mount.

6. The assembly according to claim 5, further comprising a second arm being hingedly coupled to said first arm, said strut being attached to said second arm.

7. The assembly according to claim 2, further comprising a foot being attached to said lower end, said foot being pivotally coupled to said lower end.

8. A ladder stabilization system configured to prevent a ladder from tipping laterally, said system comprising:
a ladder having a pair of front legs, a pair of back legs and a platform, said platform having a front side and a back side, each of said front legs and said back legs having a top end and a bottom end, said top end of each of said front legs and each of said back legs being hingedly coupled to said platform, said front legs being positioned adjacent to said front side, said back legs being positioned adjacent to said back side, said front legs and said back legs extending downwardly for said platform, said front legs and said back legs being positioned in a deployed positioned having said bottom end of said back legs being spaced apart from said bottom end of said font legs, said bottom ends being configured to abut a support surface;
a pair of supports, each of said front legs having an outer surface, each of said outer surfaces having one of said supports attached thereto, each of said supports being pivotally extendable laterally away from an associated one of said front legs to inhibit tipping of said ladder, each of said supports comprising:
a strut having an upper end and a lower end, said strut being telescopic and having a selectively adjustable length;
a coupler being attached to said outer surface and to said strut adjacent to said upper end, said coupler including:
a mount attached to said outer surface, said mount being rotational with respect to said ladder;
a first arm being attached to sand extending outwardly from said mount; and
a second arm being hingedly coupled to said first arm, said strut being attached to said second arm; and
a foot being attached to said lower end, said foot being pivotally coupled to said lower end.
